(19) United States
(12) Patent Application Publication
(10) Pub. No.: US 2013/0087100 A1
(43) Pub. Date: Apr. 11, 2013

(54) ARRANGEMENT AND METHOD FOR CONTROL IN AN ANIMAL HANDLING SYSTEM

(71) Applicant: Mats Nilsson, Tumba (SE)

(72) Inventor: Mats Nilsson, Tumba (SE)

(73) Assignee: DELAVAL HOLDING AB, Tumba (SE)

(21) Appl. No.: 13/704,646

(22) PCT Filed: Jun. 17, 2011
(86) PCT No.: PCT/SE11/50770

§ 371 Date: Dec. 17, 2012

Related U.S. Application Data
(60) Provisional application No. 61/359,046, filed on Jun. 28, 2010.

(30) Foreign Application Priority Data
Jun. 23, 2010 (SE) 1050673-1

(51) Int. Cl. A01J 5/00; A01J 7/04

(52) U.S. Cl. CPC A01J 5/007; A01J 7/04; A01J 5/003
USPC 119/14.02; 119/14.08; 119/14.04

(57) ABSTRACT

An arrangement for control in an animal handling system includes an automated teat preparation station for preparation of teats of animals to be milked and a separately located milking system for milking of the animals. The arrangement is operatively connected to the teat preparation station and the milking system and includes a unit estimating a time left until the milking system is ready to receive a further animal to be milked; a unit estimating, for a animal present at the teat preparation station, a time for preparation of the teats of the animal; and initiating unit initiating automated preparation of the teats of the animal at a point of time, which is dependent on the estimated time left until the milking system is ready to receive a further animal to be milked and on the estimated time for preparation of the teats of the animal.

### TECHNICAL FIELD OF THE INVENTION

The present invention relates generally to dairy farming, and more specifically the invention relates to arrangements, methods, and a computer program product for control in an animal handling system, as well as to the animal handling system itself.

### DESCRIPTION OF RELATED ART

A rotary parlor milking system comprises a rotating platform which animals enter and leave in a sequential order in order to be milked. The rotating platform comprises a plurality of milking stalls, each provided with milking equipment for milking of an animal present in the milking stall. The rotating platform rotates with the milking stalls and the animals which have entered the rotating platform, while the animals are milked. Each milking animal leaves the platform after one revolution of the rotating platform when the milking has been completed.

Such rotary parlor milking system may be provided with a teat preparation station in front thereof, that is, each of the animals passes the teat preparation station before entering the rotating platform of the rotary parlor milking system. In the teat preparation station, the milking animals get their teats cleaned, stimulated and optionally foremilked. WO 2008/140407 discloses such arrangement.

### SUMMARY OF THE INVENTION

The inventors of the present invention have noted that with the arrangement of the prior art sometimes the teat preparation of a milking animal is completed while still there is no free milking stall of the milking system for the milking animal to enter. As a result the milk letdown stimulation level may decrease while awaiting the milking system to be ready for the milking animal to enter, and as a result the milking may not start appropriately. Alternatively, if the milking animal is easily stimulated the milk letdown may start too early and the floor will be sprayed with milk.

While these problems may occur in any kind of milking system, it may be particularly cumbersome in a rotary parlor milking system since the speed of the rotating platform is dependant on the milking time of a large number of milking animals such that the milking of each milking animal on the rotating platform is completed during about one revolution. This means that if the milking of a milking animal on the platform is delayed or is longer than expected for some reason, the speed of the rotating platform has to slow down. As a result, the rotary parlor milking system will be ready to receive a further milking animal to be milked at a later stage, and thus the milking animal at the teat preparation station, after having her teats prepared, may have to wait considerable time before being milked.

On the other hand, if the teat preparation is initiated too late, the milking system may have to await the completion the preparation of the teats of the milking animal, and this reduces obviously the throughput of the milking system.

An object of the present invention is therefore to provide an arrangement, a milk handling system, a method, and a computer program product, respectively, by which the above disclosed problems can be eliminated or at least mitigated.

A further object of the invention is to provide such arrangement, milk handling system, method, and computer program product, which are capable of providing optimum milk production and high throughput.

A yet further object of the invention is to provide such arrangement, method, milk handling system, and computer program product, which are robust, effective, fast, precise, accurate, reliable, safe, easy to use, and of reasonable cost.

These objects are according to the present invention attained by arrangements, methods, milk handling systems, and a computer program product as claimed in the appended patent claims.

According to a first aspect of the invention, an arrangement is provided for control in an animal handling system comprising an automated teat preparation station for automated preparation of the teats of milking animals to be milked and a milking system for milking of the milking animals after their teats have been prepared. The arrangement is operatively connected to the teat preparation station and to the milking system and comprises a first estimator, a second estimator, and initiating means. The first estimator is arranged to estimate a time left until the milking system is ready to receive a further milking animal to be milked, and the second estimator is arranged, for a milking animal present at the teat preparation station, to estimate a time for preparation of the teats of the milking animal. Finally, the initiating means is arranged to initiate automated preparation of the teats of the milking animal at a point of time, which is dependent on (i) the estimated time left until the milking system is ready to receive a further milking animal to be milked, and on (ii) the estimated time for preparation of the teats of the milking animal.

Preferably, the initiating means is arranged to initiate preparation of the teats of the milking animal at a point of time such that the preparation of the teats of the milking animal present at the teat preparation station is completed approximately when the milking system is ready to receive a further milking animal to be milked.

By the present invention, teat preparation is correlated with milking dynamically such that at each instant teat preparation of a milking animal is commenced and performed such that it is completed just when the milking system is ready to receive the milking animal for milking. No milking animals have to await the milking system to complete milking of an earlier milking animal with the possible result of too early milk letdown or a decrease in the milk letdown stimulation level. At the same time, the milking system will never be halted due to the teat preparation of a milking animal in the teat preparation station having started too late.

Advantageously, the time for preparation of the teats of the milking animal is estimated on an animal individual basis since teat preparation times may vary from animal to animal.

In one embodiment the invention is implemented in a rotary parlor milking system provided with a teat preparation station in front thereof.

According to a second aspect of the invention a milk handling system is provided, which comprises a milking system and a teat preparation station in front thereof, and the control arrangement of the first aspect of the invention.

According to a third aspect of the invention, a method for control in an animal handling system comprising a milking system and a teat preparation station in front thereof is provided. According to the method a time left until the milking system is ready to receive a further milking animal to be milked is estimated, a time for preparation of the teats of a milking animal present at the teat preparation station is estimated, and preparation of the teats of the milking animal is initiated at a point of time, which depends on the estimated time left until the milking system is ready to receive a further milking animal to be milked and on the estimated time for preparation of the teats of the milking animal.

According to a fourth aspect of the invention, a computer program product is provided, which is loadable into the internal memory of a computer and comprises software code portions for carrying out the method of the third aspect of the invention.

Further characteristics of the invention, and advantages thereof, will be evident from the following detailed description of preferred embodiments of the present invention given hereinafter and the accompanying FIGS. 1-2, which are given by way of illustration only, and are thus not limitative of the present invention.

### BRIEF DESCRIPTION OF THE DRAWINGS

FIG. 1 illustrates schematically an animal handling system comprising a milking system, a teat preparation station, and a control arrangement according to an embodiment of the invention.

FIG. 2 is a flow scheme of a method for controlling in an animal handling system according to an embodiment of the invention.

### DETAILED DESCRIPTION OF EMBODIMENTS

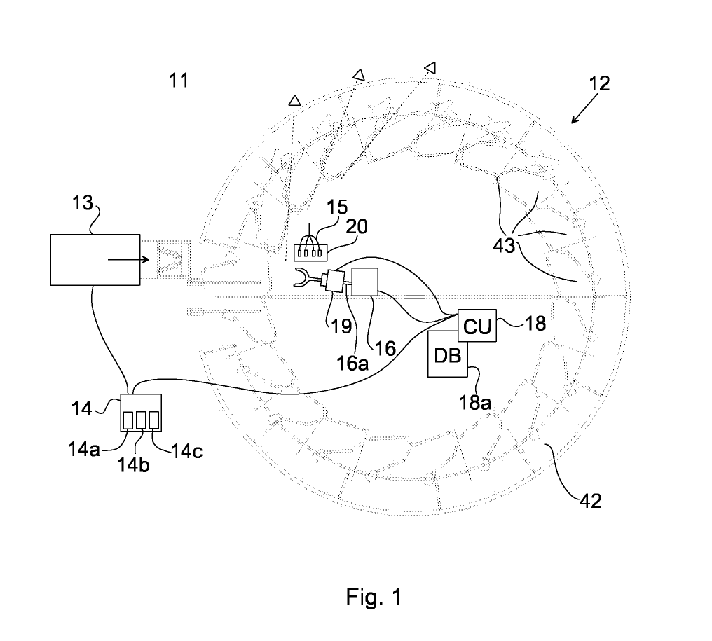

FIG. 1 illustrates schematically an animal handling system 11 comprising an automated milking system 12 for automated milking of milking animals, an automated teat preparation station 13 for automated preparation of the teats of milking animals to be milked, and a control arrangement 14 for control in the animal handling system 11.

The automated milking system 12 is a rotary parlor milking system comprising a rotatable carousel or rotating platform 42, on which a plurality of milking stalls 43 are arranged. Milking animals enter advantageously the milking stalls 43 in a sequential order at a single entry of the rotary parlor milking system 12. Each of the milking stalls 43 comprises milking equipment including teat cups 15 that are attached to the teats of the milking animal present in the milking stall 43 prior to milking. A magazine 20 for storing the teat cups 43 when they are not in use is provided. For sake of simplicity teat cups 15 and a magazine 20 are illustrated only for one of the milking stalls 43. The rotary parlor milking system 12 may be of parallel, tandem, or, as being illustrated in FIG. 1, herringbone configuration.

One or more milking robots 16, each with a vision system 19 mounted on its movable robot arm 16a, may be provided for attachment of the teat cups 15 to the teats of the milking animals present in the milking stalls 43. The milking robot(s) 16 may be stationary with respect to the rotating platform 42 of the rotary parlor milking system 12, or may be movable back and forth in e.g. a circumferential direction in order to serve more than one milking stall 43. The vision system 19 may be located elsewhere than on the movable robot arm 16a such as e.g. located stationary with respect to the movable robot arm 16a.

Each milking animal present on the rotating platform 42 is being milked while the rotating platform rotates one revolution. The milking animals leave advantageously the milking stalls 43 in the same sequential order as they entered the milking stalls at a single exit of the rotary parlor milking system 12.

A processing and control device 18 is provided for processing and controlling of the rotary parlor milking system 12, and comprises typically a microcomputer, suitable software, and a database 18a of the milking animals served by the milking rotary parlor milking system 12. Such database includes typically information of the milking animals, such as e.g. when the milking animals were milked last time, their milk production, their milk quality, etc. In particular, the processing and control device 18 is operatively connected to the milking equipments and the milking robot 16 for control of the operations thereof.

The teat preparation station 13 is arranged to prepare the teats of the milking animals prior to being milked and is located separate from the rotary parlor milking system 12. Such teat preparation includes cleaning, foremilking, and/or milk letdown stimulation. A teat preparation station which can be used in the present invention is disclosed in the above-identified WO 2008/140407, the contents of which being hereby incorporated by reference. Teat cleaning and pre-milking equipment for use in the teat preparation station 13 comprise e.g. those disclosed in U.S. Pat. No. 6,626,130; U.S. Pat. No. 6,591,784; U.S. Pat. No. 6,553,942; U.S. Pat. No. 5,211,132; U.S. Pat. No. 5,235,937; and U.S. Pat. No. 4,305,346; U.S. Pat. No. 6,321,682; B1 U.S. Pat. No. 6,155,204; EP 0 830 055 B1; and WO 2005/067702 A1, either directly or after modifications readily made by a person skilled in the art. The contents of the above documents are hereby incorporated by reference. The teat preparation station 13 and its equipment may be controlled by a separate control device operatively connected to the processing and control device 18 of the rotary parlor milking system 12 (not illustrated), or may be controlled directly by the processing and control device 18.

Typically, the milking animals pass the teat preparation station 13 sequentially, one by one, in the same order as they enter the milking stalls 43 of the rotary parlor milking system 12 even if teat preparation stations for teat preparation of a plurality of milking animals concurrently are conceivable.

The control arrangement 14 is operatively connected to the teat preparation station 13 and to the rotary parlor milking system 12 and comprises first estimating means 14a for estimating a time left until the rotary parlor milking system 12 is ready to receive a further milking animal to be milked, second estimating means 14b for estimating, for a milking animal present at the teat preparation station 13, a time for preparation of the teats of the milking animal, and initiating means 14c for initiating automated preparation of the teats of the milking animal at a point of time, which depends on the estimated time left until the rotary parlor milking system 12 is ready to receive a further milking animal to be milked and on the estimated time for preparation of the teats of the milking animal.

The control arrangement 14 may be implemented as a separate microcomputer, whereby the first 14a and second 14b estimating means and the initiating means 14c may be different programs or subroutines run on the microcomputer. However, more preferably the control arrangement is integrated with the processing and control device 18, and is simply implemented in software therein.

The initiating means 14c is preferably arranged to initiate preparation of the teats of the milking animal at a point of time such that the preparation of the teats of the milking animal present at the teat preparation station 13 is completed approximately when the rotary parlor milking system 12 is ready to receive a further milking animal to be milked. By such provisions it can be safeguarded on one hand that the rotary parlor milking system 12 can be loaded continuously with milking animals to be milked, and on the other hand that milking animals do not have to wait to get milked after their teats have been prepared. The milk ejection stimulation level may decrease, or may become so high that milk will spray the floor. Both scenarios would have a negative impact on the milk production.

The first estimating means 14a may be arranged to estimate the time left until the rotary parlor milking system 12 is ready to receive a further milking animal to be milked based on historical data regarding milking times for the milking animals that are presently being milked by the rotary parlor milking system 12. However, more preferred is a dynamic approach, wherein the first estimating means 14a is arranged to estimate the time left until the rotary parlor milking system 12 is ready to receive a further milking animal to be milked based on ongoing measurements regarding the progress of the milking by the rotary parlor milking system 12. Such ongoing measurements regarding the progress of the milking by the rotary parlor milking system 12 may include measurements of milk flows or milking times during the milking by the rotary parlor milking system 12.

The second estimating means 14c may be arranged to estimate the time for preparation of the teats of the milking animal based on historical data regarding teat preparation times for that milking animal, or for a group of milking animals. Most efficient is a solution with animal individual historical data for the teat preparation times.

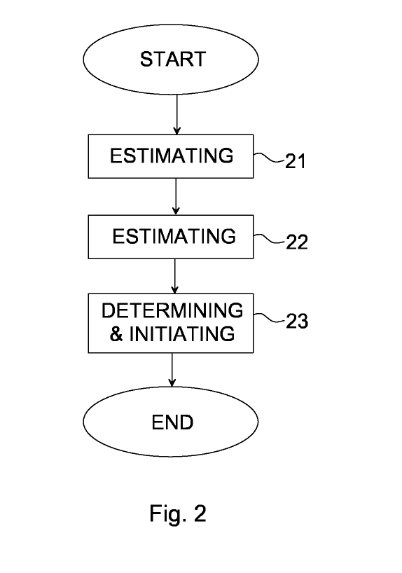

FIG. 2 is a flow scheme of a method for control in an animal handling system comprising a milking system and a teat preparation station in front of the milking system, such as e.g. the milk handling system 11 of FIG. 1. According to the method a time left until the milking system is ready to receive a further milking animal to be milked is, in a step 21, estimated. Next, for a milking animal present at the teat preparation station, a time for preparation of the teats of the milking animal is, in a step 22, estimated. Steps 21 and 22 can of course take place simultaneously. Finally, in a step 23, automated preparation of the teats of the milking animal in the teat preparation station is determined to be initiated at a point of time, which is dependent on the estimated time left until the milking system is ready to receive a further milking animal to be milked and on the estimated time for preparation of the teats of the milking animal, and the teat preparation is initiated at the determined point of time.

The estimations may be performed as disclosed above with reference to FIG. 1. The initiation is controlled such that the milking animal will not be stimulated too early and such that the teat preparation causes no delays for the milking system. The method is advantageously repeated for each animal entering the teat preparation station.

Further, a computer program product loadable into the internal memory of a computer is provided, wherein the computer program product comprises software code portions for carrying out the above method when the computer program product is run on the computer.

While the present invention has been described in a variety of embodiments it is obvious that they can be modified in a variety of more versions without departing from the scope of the present invention. In particular, the present invention may be implemented and/or encompass both automated and manual milking systems, and other types of milking system than the rotary parlor milking system. For example, one automated teat preparation station could be used together with one or several automatic milking stations.

1-15. (canceled)

16. A control arrangement (14) for an animal handling system (11), which animal handling system comprises i) at a first location, an automated teat preparation station (13) for automated preparation of teats of milking animals to be milked, and ii) at a separate, second location, a milking system (12) for milking of the milking animals after their teats have been prepared by the automated teat preparation station (13), the first location being separate from the second location so that after the teats of the milking animals have been prepared by the automated teat preparation station (13), each milking animal moves from the first location to the second location for being milked by milking system (12), the control arrangement being operatively connected to the teat preparation station and to the milking system and comprising:
a first estimating unit (14a) operatively connected to estimate a time left until the milking system is ready to receive a further milking animal to be milked;
a second estimating unit (14b) operatively connected to estimate, for a milking animal present at the teat preparation station, a time for preparation of the teats of the milking animal; and
an initiating unit (14c) operatively connected to the first and second estimating units (14a, 14b) and arranged to initiate automated preparation of the teats of the milking animal at a point of time dependent on said estimated time left until the milking system is ready to receive a further milking animal to be milked and on said estimated time for preparation of the teats of the milking animal.

17. The arrangement of claim 16, wherein the initiating unit is arranged to initiate preparation of the teats of the milking animal at a point of time such that the preparation of the teats of the milking animal present at the teat preparation station is completed approximately when the milking system is ready to receive a further milking animal to be milked.

18. The arrangement of claim 16, wherein the first estimating unit is arranged to estimate the time left until the milking system is ready to receive a further milking animal to be milked based on historical data regarding milking times for the milking animals being milked by the milking system.

19. The arrangement of claim 16, wherein the first estimating unit is arranged to estimate the time left until the milking system is ready to receive a further milking animal to be milked based on ongoing measurements regarding progress of the milking by the milking system.

20. The arrangement of claim 19, wherein the ongoing measurements regarding the progress of the milking by the milking system includes measurements of milk flows during the milking by the milking system.

21. The arrangement of claim 19, wherein the ongoing measurements regarding the progress of the milking by the milking system includes measurements of milking times during the milking by the milking system.

22. The arrangement of claim 16, wherein the second estimating unit is arranged to estimate the time for preparation of the teats of the milking animal based on historical data regarding teat preparation times for the milking animal.

23. The arrangement of claim 16, wherein the second estimating unit is arranged to estimate the time for preparation of the teats of the milking animal based on historical data regarding teat preparation times for a plurality of milking animals.

24. A combination of the arrangement of claim 16 and the animal handling system (11), wherein,
the milking system (12) is a rotary parlor milking system comprising a rotatable platform (42) and a plurality of milking stalls (43) arranged on the rotatable platform (42), each milking stall comprising milking equipment for milking the animals, the second location being associated with the milking stalls (43), and
the first location of the teat preparation station (13) is located outside an outermost perimeter of the rotatable platform (42).

25. The combination of claim 24, wherein,
the milking system comprises a single entry arranged so that the milking animals enter the milking stalls in a sequential order, and
the teat preparation station is arranged so that the milking animals pass through the teat preparation station, one by one, in the same sequential order as the milking animals subsequently enter the milking stalls.

26. A combination of the arrangement of claim 16 and the animal handling system (11).

27. A an animal handling system (11), comprising:
at a first location, an automated teat preparation station (13) for automated preparation of teats of milking animals to be milked;
at a separate, second location, a milking system (12) for milking of the milking animals after their teats have been prepared by the automated teat preparation station (13), the first location being separated from the second location so that after the teats of the milking animals have been prepared by the automated teat preparation station (13), the milking animals move from the first location to the second location for being milked by milking system (12); and
a control arrangement (14) operatively connected to the teat preparation station and to the milking system, the control arrangement comprising
i) first estimating unit (14a) connected to estimate a time left until the milking system is ready to receive a further milking animal to be milked;
ii) second estimating unit (14b) connected to estimate, for a milking animal present at the teat preparation station, a time for preparation of the teats of the milking animal present at the teat preparation station; and
iii) an initiating unit (14c) operatively connected to the first and second estimating units (14a, 14b) and arranged to initiate automated preparation of the teats of the milking animal at a point of time dependent on said estimated time left until the milking system is ready to receive a further milking animal to be milked and on said estimated time for preparation of the teats of the milking animal.

28. The animal handling system of claim 27, wherein the milking system comprises milking stalls arranged for milking a plurality of the milking animals concurrently.

29. The animal handling system of claim 28, wherein the milking system is a rotary parlor milking system (12).

30. A control method for an animal handling system (11), which animal handling system comprises i) at a first location, an automated teat preparation station (13) for automated preparation of teats of milking animals to be milked, and ii) at a separate, second location, a milking system (12) for milking of the milking animals after their teats have been prepared by the automated teat preparation station (13), the first location being separated from the second location so that after the teats of the milking animals have been prepared by the automated teat preparation station (13), the milking animals move from the first location to the second location for being milked by milking system (12), the control method comprising the steps of:
with a first estimating unit (14a), estimating a time left until the milking system is ready to receive a further milking animal to be milked;
with second estimating unit (14b), estimating, for a milking animal present at the teat preparation station, a time for preparation of the teats of the milking animal; and
with an initiating unit (14c), initiating automated preparation of the teats of the milking animal at a point of time, which is dependent on said estimated time left until the milking system is ready to receive a further milking animal to be milked and on said estimated time for preparation of the teats of the milking animal,
wherein the first and second estimating units and the initiating unit are comprised of a computer device of the animal handling system.

31. The method of claim 30, wherein the preparation of the teats of the milking animal is initiated at a point of time such that the preparation of the teats of the milking animal present at the teat preparation station is completed approximately when the milking system is ready to receive a further milking animal to be milked.

32. The method of claim 30, wherein the time left until the milking system is ready to receive a further milking animal to be milked is estimated based on at least one of i) historical data regarding milking times for the milking system and ii) on ongoing measurements regarding the progress of the milking by the milking system.

33. The method of claim 30, executed by a computer as directed by a computer program product stored on a non-transitory computer readable medium and loaded into the internal memory of the computer (14).
